(19) United States
(12) Patent Application Publication
(10) Pub. No.: US 2024/0334872 A1
(43) Pub. Date: Oct. 10, 2024

(54) METHOD AND APPARATUS FOR COMPUTER-AIDED PREPARATION OF AN ELECTRONIC YIELD MAP

(71) Applicant: Deere & Company, Moline, IL (US)

(72) Inventor: Sebastian Blank, Mannheim (DE)

(21) Appl. No.: 18/626,134

(22) Filed: Apr. 3, 2024

(30) Foreign Application Priority Data
Apr. 6, 2023 (DE) 10 2023 108 956.0
Mar. 11, 2024 (EP) 24162747.0

(51) Int. Cl. A01D 41/127

(52) U.S. Cl. CPC A01D 41/127

(57) ABSTRACT

Systems, apparatus, and methods are disclosed. An example method for preparing an electronic yield map includes a computer device to perform operations including: identifying, based on a yield map, a location of a crop edge that separates a first part of a field from a second part of the field, the second part of the field containing at least one track on which a harvesting machine has travelled and picked a crop; identifying, based the yield map, a first time at which the harvesting machine crossed the crop edge while driving on the track; identifying, based on a signal generated from a sensor, a second time when the harvesting machine started or stopped picking the crop while driving on the track; identifying a time delay between the first time and the second time; and correcting the yield map based on the identified time delay.

### RELATED APPLICATION

It is noted that this patent claims priority from German Patent Application Number 10 2023 108 956.0, which was filed on Apr. 6, 2023, and is hereby incorporated by reference in its entirety.

### TECHNICAL FIELD

This description relates generally to methods and arrangements for the computer-aided preparation of electronic yield maps. In some examples, signals that are generated by one or more sensors, which interact with crop in a harvesting machine during the harvesting of a field, are georeferenced and plotted with associated time data.

### BACKGROUND

Agricultural harvesting machines are generally equipped with devices for yield mapping. These devices may include a sensor for detecting properties (e.g., throughput, moisture content, and the like) of the crop inside the harvesting machine. The devices may also include a position determination unit that receives signals from a Global Navigation Satellite System (GNSS). The device then uses the detected properties and the determined position to generate the yield map. As used above and herein, a yield map refers to data that shows how throughput of a harvesting device (and, in some examples, other various properties of a crop) change based on the position of the harvesting machine within a field. Yield maps can be used for a variety of precision-agricultural purposes. Such purposes may include but are not limited to fertilization planning for the next season, invoicing purposes, proactive activation of the harvesting machine during a subsequent harvesting process, supplying self-learning plant growth models with training data, and the like.

### BRIEF DESCRIPTION OF THE DRAWINGS

FIG. 1 is an illustrative example of a combine harvester having a measuring device for throughput detection.

FIG. 2 is an illustrative example of a field during harvesting by the combine harvester of FIG. 1.

FIG. 3 shows an example flowchart to generate a yield map.

### DETAILED DESCRIPTION

Due to the structure of harvesting machines, a time delay exists between when a plant is picked from a location at which it grows and when the plant interacts with a sensor on the harvesting machine. In a combine harvester, for instance, the plant or its grain may run through the harvesting header, the feeder house, the threshing and separating device, the cleaning and the grain elevator before it interacts with a conventional baffle plate sensor at the outlet of the grain elevator. In some examples, the foregoing time delay is an order of magnitude above 10 seconds. Forage harvesters also have time delays that are of similar magnitude to combine harvesters. In forage harvesters, yield measurement takes place at the feed rollers or in the discharge spout.

Because of the delay time that exists when crop runs through a harvesting machine, yields can be measured if plants are no longer being harvested but are still being processed. Similar problems exist for other harvesting machines (e.g., cotton pickers, sugar cane harvesters, and the like) in which crop and sensing of the crop are spaced from one another spatially and therefore temporally.

Some techniques that develop a yield map assume the foregoing time delay is a constant value. Such techniques use the constant value when evaluating sensor values. Other techniques use the speed of crop conveyors or proactive sensors to estimate a time delay and to assign yields across the width of a harvesting header.

Another technique to develop yield maps accounts for the time delay during post-processing of the yield maps. In such techniques, the start and end time of the yields measured during travel over the field may be shifted forward by predetermined amounts. Alternatively, such techniques may derive the time delays from the yield curves by identifying the crop edges on the basis of increasing or decreasing signals or comparing the yield maps with aerial images.

In practice, the time delay depends, among other things, on field (topography) and plant properties (maturity, grain size, throughput), machine configuration (rotary tines, gratings, attachment type, i.e. transverse conveying by auger or belt) and machine settings (driving speed, rotor speed, adjustment of runners in the separator, resultant tailings, and the like). One or more of the foregoing parameters may vary over time and/or on location, resulting in different time delays based on a particular use case.

Because time delays depend on various parameters, failure to include one or more of the parameters when determining a delay time may lead to errors in the yield maps. Alternatively, the use of additional sensors to measure the throughput time or an aerial image increases the cost of developing a yield map. Furthermore, a subsequent determination of the time delays on the basis of the yield maps still contains uncertainties in at least the assignment of the measured yields to the locations within the field. Such uncertainty remains because the shape of the curve of the yields at best an approximate time of when a crop edge was crossed. Given the lack of information about the location of the associated crop edge, the respective location cannot be determined using such previous techniques.

Example methods, apparatus, and systems described herein include an improved method to prepare an electronic yield map. An example method includes:
(a) identifying the location of one or more headlands or a different place with a crop edge on the field on the basis of the yield map,
(b) identifying the location of one or more crop edges, which separate the headland or the different place from a part of the field on which the harvesting machine has travelled on at least one track and picked crop, on the basis of the yield map,
(c) identifying the time or the position of the crossing of the crop edge when driving down the track on the basis of the yield map,
(d) identifying the time or the position of the start and/or end of the picking of crop when driving down the track on the basis of the signals of the sensors plotted in the yield map,
(e) identifying a time delay or a spatial offset between the identified time or the position of the crossing of the crop edge and the identified time or the position of the start and/or end of the picking of crop, and
(f) correcting the yield map on the basis of the identified time delay or the spatial offset.

Using the example method above, and without using additional sensors, the time delay between picking the crop and the subsequent sensing are detected and compensated based on the yield map, the track travelled by the harvesting machine, the associated sensor signals, and time data plotted in the yield map. The example method also enables detection of: a) the location of the crop edge at the start and/or end of the track, and b) where along the track crop was picked for the first and/or last time. Accordingly, a device implemented according to the teachings described herein can implement the example method to detect the time delay and/or the spatial offset based on the associated times and correct a yield map as needed.

The location of a crop edge is not limited to the end of a headland. For example, the crop edge may be a lane which is intentionally cut through the field centrally. Such a crop edge may be used to divide the field into patches or to apply the techniques described herein to places beyond the headland. Alternatively, the crop edge may be at a location where no crop is present for other reasons (e.g. because no crop was grown at the location for either intentional, topographical, or environmental reasons). In examples where a harvesting machine harvests a portion of crop to create a lane, the crop edge can be detected based on the path that the harvesting machine travelled. In other examples, a location not populated with crops is identified as the crop edge based on the path of the harvesting machine and/or the associated yields. As used above and herein, the term “harvesting machine” may refer to any harvesting machine that picks crops. Examples of a harvesting machine include but are not limited to a combine harvester, a forage harvester, a baler, and the like.

The time delay between a crop being picked by a harvesting header and the crop reaching the sensor leads may cause a corruption to yield maps. The corruption occurs because the sensors generate signals and produce plots in the yield map after the crop has already been picked. Advantageously, step (f) of the example method described above compensates for this corruption such that the generated yield map contains the sensor values for the respective place at which the respective plant (or other crop constituents) were picked by the harvesting machine, rather than where the plant interacts with the sensor.

In some examples described herein, the time delay or the spatial offset is determined as a whole for the entire field. In other examples described herein, the time delay or the spatial asset is determined separately for individual tracks or for segments of individual tracks.

Advantageously, in step (d) of the example method described above, the start and/or the end of picking the crop can be detected based on a change of the signals of the sensor (e.g., when a signal rises above or falls below a threshold value). The sensors can detect the throughput and/or the moisture and/or other contents of the crop.

The example method described above can be carried out during the harvesting process or thereafter by any computer device. In some examples, the computer device is implemented within the harvesting machine. In other examples, the computer device is implemented externally from the harvesting machine (e.g., at a remote location). In such examples, the computer device may transfer the yield map to the harvesting machine through any suitable form of wired and/or wireless communication.

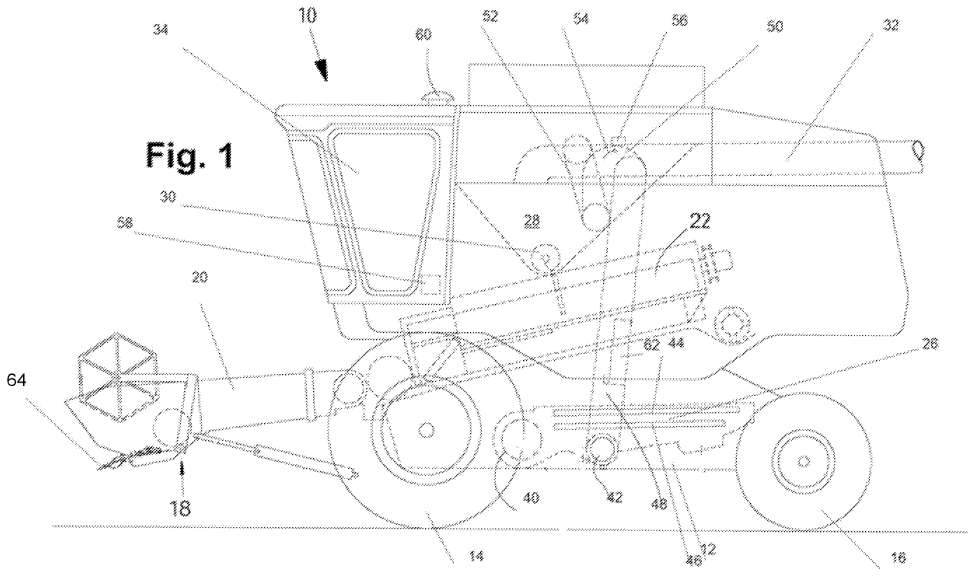

FIG. 1 is an example implementation of a self-propelled harvesting machine. The chassis 12 of FIG. 1 is supported by and moved by the driven front wheels 14 and the steerable rear wheels 16. The wheels 14, 16 are set in rotation by a drive train to move the combine harvester 10 (e.g., to a field that is to be harvested). As used above and herein, direction indications (e.g., front and rear) are with respect to the orientation of the harvester 10 as shown in FIG. 1.

The harvesting header 18, shown in the form of a cutting unit in FIG. 1, is removably attachable to the front-end region of the combine harvester 10. The harvesting header 18 harvests crop (in the form, e.g., of cereal or other threshable cereal crops from the field) to feed the crop upwardly and rearwardly through the feeder house system 20 to the axial threshing unit 22.

In the example of FIG. 1, the output of the harvesting header 18 (which contains both crop and contaminants) passes through threshing concaves and gratings in the axial threshing unit 22 and into the cleaning device 26. In other examples, the axial threshing unit 22 is replaced by a tangential threshing drum with downstream straw walker or axial separating devices.

The cleaning device 26 cleans the mixture by using the grain auger 42 and the grain elevator 48. In particular, the grain auger 42 and the grain elevator 48 separate and transfer the crop first to the transfer housing 50 and then to the filling auger 52, which conveys said crop into a grain tank 28. The cleaned crop from the grain tank 28 can be discharged through a discharge system using the transverse auger 30 and the discharge conveyor 32.

The cleaning device 26 includes an upper screen 44 and a lower screen 46. The fan 40 flows air rearward and upward through the screens 44 and 46. The size of the screen openings and the rotational speed of the fan 40 may be varied using an automatic cleaning setting or manually by an operator within the cab 34. The mixture that is output at the rear end from the upper screen 44 is distributed on the field by a chaff spreader or a straw chopper. In contrast, the mixture that is output at the rear end from the lower screen 46 is fed by a tailing conveyor to a further threshing process. The additional threshing process may be implemented by the axial threshing unit 22 or by a separate rethresher.

The moisture sensor 62 detects the moisture of the crop that travels through the grain elevator 48. The moisture sensor 62 may be implemented within or adjacent to the grain elevator 48. The grain output of the grain elevator 48 makes contact with the baffle plate 54. The baffle plate 54 is articulated at its upstream end in a pivotable manner against a defined (spring) force. Accordingly, the baffle plate 54 can pivot about an axis that is towards the forward direction of the harvester 10 (e.g., towards the cab 34). Accordingly, the position of the baffle plate can be detected by a sensor and used for throughput detection.

The position determination device 60 receives signals from satellites of a GNSS (e.g., Global Positioning System (GPS), Galileo, and the like). The position determination device 60 uses the satellite signals to calculate the current position of the combine harvester 10. In some examples, the position determination device 60 also uses local correction signals (e.g., Differential Global Positioning System (DGPS), Real-time kinematic positioning (RTK), and the like) to determine the position.

During harvesting, the computer device 58 stores the position detected by the position determination device 60, corresponding timestamps, signals from the throughput sensor 56, and georeferenced signals from the moisture sensor 62 together. In some examples, moisture sensor 62 is replaced or supplemented by a different sensor (e.g., a Near Infrared (NIR) sensor) for detecting any type of desired contents. The sensors 56 and 62 may be located at any location on the combine harvester 10 to detect the throughput and/or contents of the crop. The sensors 56 and 62 may also use any suitable measuring technique to measure characteristics of the crop. In some examples, the signals of the position determination device 60 is used to automatically steer the combine harvester 10.

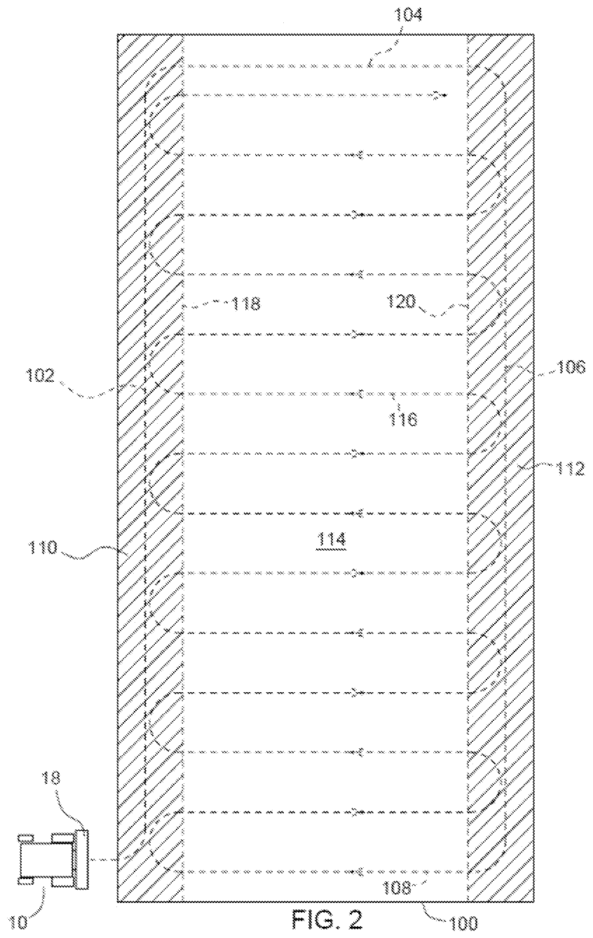

FIG. 2 shows an example illustration of a field 100 during harvesting. The combine harvester 10 begins harvesting in the example of FIG. 1 by driving around the outer perimeter of the field 100. In the process, the combine harvester 10 travels the paths 102, 104, 106 and 108. The combine harvester 10 also harvests the areas 110, 112 when traveling the paths 102 and 106, respectively.

In some examples, the areas 110, 112 are referred to as headland. The combine harvester 10 uses the headland when harvesting the area 114 (e.g., the central part of the field 100). In particular, the combine harvester 10 turns within the areas 110, 112 in order to drive across and harvests the individual tracks 116 on the field 100.

The tracks 102, 104, 106 108, and 116 of FIG. 2 form one example technique to harvest the field 100. In general, the combine harvester 10 may use any combination of headlands and individual tracks to harvest the field 100. For instance, in some examples, the combine harvester 10 generates headlands using more land than paths 102, 104, 106 108. As a result, the widths of the headlands may be any number of times wider than the width of the harvesting header 18. In the example of FIG. 2, the tracks 116 are parallel with the shorter side of the field 100 (e.g. parallel with track 104). In other examples, the tracks 116 are parallel with the longer side of the field 100 (e.g., parallel with track 102) to minimize the number of turns within the headlands. Furthermore, while FIG. 2 shows the combine harvester 10 driving such that the individual tracks 116 are harvested directly after one another, in other examples, the combine harvester 10 omits certain tracks 116 in a given pass and harvests said tracks later to simplify the turning processes.

The computer device 58 stores georeferenced signals generated by the sensors 56 and 62. The signals contain data for the throughput (provided by sensor 56) and the moisture and/or other contents of the crop (provided by sensor 62) that do not correlate directly with the location where the corresponding crop was picked. This offset occurs due to the time it takes for the crop to be cut off by the cutting bar 64 of the harvesting header 18, then travel through the harvesting header 18, the feeder house 20, the axial threshing unit 22, the cleaning device 26, the grain auger 42 and the grain elevator 48 before reaching the sensors 56, 62. Notably, the magnitude of the offset (e.g., the time delay) may depend on a variety of factors and may change dynamically. As a result, a time delay exists between when the combine harvester 10 starts to harvest crop (e.g., by entering the central part 114 of the field) and when the sensors 56 and/or 62 starts to identify the crop. Similarly, a time delay exists between when the combine harvester 10 stops harvesting crop (e.g., by exiting the central part 114 of the field) and when the sensors 56 and/or 62 stop identifying the crop. In addition, a spatial offset occurs because the position determination device 60 and cutting bar 64 are implemented at different locations on the combine harvester 10.

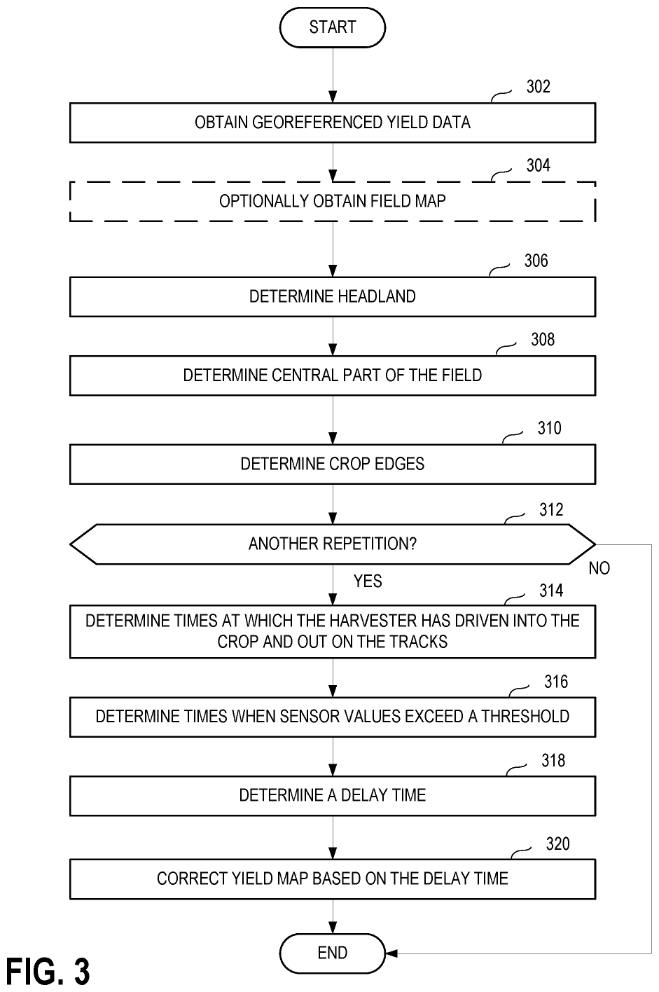

The computer device 58 solves or mitigates issues caused by the foregoing time delays by preforming operations according to the example flowchart of FIG. 3. At block 302, the computer device 58 obtains the georeferenced data from the sensors 56 and/or 62 as input values. The computer device 58 also obtains associated position data from the position determination device 60, and records associated time data, at block 302.

At block 304, the computer device 58 optionally obtains a map of the field 100. In such examples, the boundaries of the field 100 may be supplied as a polygonal chain or in any desired data form.

At block 306, the computer device 58 determines the location of the headland. The computer device 58 determines the headland based on the tracks 102, 104, 106, 108, and 116 driven on during harvesting of the field 100 and based on the known width of the harvesting header 18. Using the foregoing information, the computer device 58 can detect which of the lanes were driven down and harvested initially and subsequently used as headland 110, 112 (e.g., for turning). Here, the map of the field 100 can be used for defining an outer boundary of the field 100, inside which the headland 110, 112 should be located.

At block 308, the computer device 58 determines the boundaries of the central part 114 of the field 100. To do this, the computer device 58 subtracts the headland 110, 112 from the boundaries of the field 100 that are known (on the basis of the map or the tracks 102 to 108 travelled), so that the central part 114 is left over.

At block 310, the computer device 58 determines the locations of crop edges (e.g., the crop edges 118, 120 shown in FIG. 2). The computer device 58 makes the determination based on where the combine harvester 10 drives into the still-standing crop or drives out when traveling on the tracks 116 on the central part 114. The crop edges 118, 120 generally (depending on the shape of the field 100) run transversely to the width of the harvesting header 18.

Block 312 represents possible repetitions of the next blocks 314-316 because one or more combine harvesters may process the field 100 together in combination with the combine harvester 10 of FIGS. 1 and 2. In such examples, blocks 310 to 316 are consequently possibly repeated accordingly for the further combine harvesters.

At block 314, the computer device 58 determines the times at which the combine harvester 10 has driven into the crop and out on the individual tracks 116 in the central part 114 of the field 100. The computer device 58 uses the locations of the crop edges 118, 120 to make the determination of block 314. Thus, after the block 314, the computer device 58 knows, for each of the tracks 116, when the cutting bar 64 of the harvesting header 18 started and stopped cutting the crop and the harvesting header 18 has conveyed the crop.

At block 316, the computer device 58 analyzes signals of the sensors 56 and/or 62 for each of the tracks 116. The computer device 58 performs the analysis in order to determine when the sensors 56 and/or 62 started or stopped identifying the crop. For example, the sensors 56 and/or 62 starts to identify the crop when the sensor signal(s) indicate the throughput of the combine harvester 10 first exceeds a first predetermined threshold value. The predetermined threshold value is exceeded around the time when the combine harvester 10 crosses the cop edge by driving out of the headlands 118, 120 and into the central part 114 of the field 100. However, a time delay exists between the two foregoing events for the reasons provided above). Similarly, the sensors 56 and/or 62 stop identifying the crop when the sensor signal(s) indicate the throughput of the combine harvester 10 falls below a second predetermined threshold value. The throughput falls below the second predetermined threshold value around the same time that the combine harvester 10 crosses the cop edge by driving out of central part 114 of the field 100 and into the headlands 118, 120, but a time delay separates the two events.

The computer device 58 can use any desired algorithms to detect, based on the timing of signals, when the sensors 56 and/or 62 began or stopped identifying the presence of crop. Such algorithms include, for example, adaptation to a sigmoidal function.

The results of the blocks 314 and 316 make it possible for the computer device 58 to, in block 318, determine the time delay between cutting the crop with the cutting bar 64 and the sensors 56 and/or 62 detecting the crop has been harvested. To do so, the computer device 58 compares the times of blocks 314 and 316 to one another.

At block 320, the computer device 58 uses the time delay determined in block 314 to correct the yield map. For example, if at block 314 a certain time delay Δt results from driving in and out of the crop, the computer device 58 shifts all sensor values by the time delay Δt. Such corrections are possible because of the known positions and times from the foregoing blocks. In this manner, the combine harvester 10 obtains yield maps that have automatically and correctly compensated for time delay.

Various options exist at blocks 314 and 316 for the computer device 58 to take account of time delays that may be entirely different on certain individual tracks 116. A first option includes the computer device 58 determining a single, average time delay for the whole field 100. This option may be used if there is no significant change to the settings of the combine harvester 10, the driving speed, or the properties of the crop (yield, moisture) across the field 100.

A second option includes the computer device 58 taking account of the time delays for each of the tracks 116 separately. This option may be used when significant changes of the speed and/or of settings of the combine harvester 10 and/or the properties of the crop (yield, moisture) occur across the field 100.

A third option includes the computer device 58 using a statistical approach. For example, at block 314, the computer device 58 identifies the time delays that occur most often in the entire field 100 or in subregions thereof. The computer device 58 may then use these time values (or their average) at block 316 for the entire field 100. Alternatively, the computer device 58 may use the associated time delays for respective subregions of the field 100 with similar time delays.

If the field 100 was harvested by a plurality of combine harvesters 10, the blocks 312 to 320 may be repeated for the other combine harvesters. The yield maps of all combine harvesters can subsequently be combined, possibly following correction or calibration measures, to form a single yield map.

The blocks of FIG. 3 can be carried out during the harvesting process by a computer on the combine harvester 10 (e.g., the computer device 58 as shown in FIG. 1) or by a remote, aforementioned computer. The computer device 58 can correct the yield map during its generation (e.g., during or after the traveling on each track 116). The yield map can be displayed to the operator of the combine harvester 10 on a suitable user interface and stored in the computer device 58. The yield map can also be stored on any desired memory (cloud, and the like) for a proactive activation (e.g., adjust machine settings) of a combine harvester 10 in a later harvesting process or fertilization planning, or as a database for self-learning plant growth models).

The computer device 58 may also compare the locations of the crop edges 118, 120 and the locations at which crop was picked for the first or last time when driving down a track 116 (according to the signals of the sensors 56, 62) and move the locations associated with the corresponding signals of the sensors 56, 62 back by the resulting offset. Such an approach may be disadvantageous in that errors in the yield map would arise if the combine harvester 10 changes speed. However, time data is unnecessary in this procedure, so time data may not be stored with the yield map in some examples.

1. A method for preparing an electronic yield map, the method comprising:
identifying, using a computer device and based on position data, a location of a crop edge that separates a first part of a field from a second part of the field, the second part of the field containing crop to be harvested;
identifying, using the computer device and based on the position data, a first time at which a harvesting machine crossed the crop edge to enter the second part of the field;
identifying, using the computer device and based on a throughput value generated from a sensor, a second time when the sensor started to identify the crop;
identifying, using the computer device, a time delay between the first time and the second time; and
correcting, using the computer device, a yield map based on the time delay.

2. The method of claim 1, wherein the harvesting machine is a combine harvester.

3. The method of claim 2, wherein:
the time delay is caused by difference in time between when a harvesting header of the combine harvester picks the crop and when the crop reaches the sensor; and
correcting the yield map further includes compensating for the time delay such that the yield map contains throughput values from the sensor that correspond to where the crop was picked by the harvesting machine.

4. The method of claim 1, wherein determining, with the computer device, the time delay comprises one or more of determining a time delay as a whole for the field, separately for individual tracks on the field, or separately for segments of the individual tracks.

5. The method of claim 1, wherein the first part of the field is a headland.

6. The method of claim 1, further identifying the second time when the throughput value from the sensor exceeds a threshold value.

7. The method of claim 6, further including:
measuring, using the computer device and with the sensor, a moisture value of the crop;
identifying, using the computer device, the second time based on the threshold value and the moisture value.

8. The method of claim 1, further including correcting the yield map while the harvesting machine harvests the crop.

9. The method of claim 1, wherein:
the time delay is a first delay; and
the method further includes:
identifying, using the computer device and based on the position data, a third time at which the harvesting machine crossed the crop edge to exit the second part of the field;
identifying, using the computer device and based on a throughput value generated from the sensor, a fourth time when the sensor stopped identifying the crop;
identifying, using the computer device, a time delay between the third time and the fourth time; and
correcting, using the computer device, the yield map based on the second time delay.

10. The method of claim 1, further including:
identifying, based the yield map, a first position where the harvesting machine crossed the crop edge to enter the second part of the field;
identifying, based on the throughput value generated from the sensor and the position data, a second position where the sensor started to identify the crop;
identifying a spatial offset between the first position and the second position; and
correcting the yield map based on the spatial offset.

11. A harvesting machine comprising:
a harvesting header to pick crop in a field;
one or more sensors to generate signals corresponding to the crop; and
a computer device configured to:
identify, based on position data, a location of a crop edge that separates a first part of a field from a second part of the field, the second part of the field containing crop to be harvested;
identify, based on the position data, a first time at which the harvesting machine crossed the crop edge to enter the second part of the field;
identify, based on a throughput value generated from a sensor, a second time when the sensor started to identify the crop;
identify a time delay between the first time and the second time; and
correct a yield map based on the time delay.

12. The harvesting machine of claim 11, wherein:
the time delay is caused by difference in time between when the harvesting header picks the crop and when the crop reaches the one or more sensors; and
the computer device is further configured to correct the yield map by compensating for the time delay such that the yield map contains throughput values from the one or more sensors that correspond to where the crop was picked by the harvesting machine.

13. The harvesting machine of claim 11, wherein the computer device is configured to determine the time delay:
as a whole for the field; or
separately for individual tracks on the field; or
separately for segments of the individual tracks.

14. The harvesting machine of claim 11, wherein the first part of the field is a headland.

15. The harvesting machine of claim 11, wherein the computer device is configured to identify the second time when the throughput value from the sensor exceeds a threshold value.

16. The harvesting machine of claim 11, wherein the one or more sensors are to measure throughput of the crop or moisture of the crop.

17. The harvesting machine of claim 11, wherein the computer device is configured to correct the yield map after the harvesting machine harvests the crop.

18. The harvesting machine of claim 11, wherein the computer device is further configured to:
identify, based the yield map, a first position where the harvesting machine crossed the crop edge to enter the second part of the field;
identify, based on the signals generated from the one or more sensors, a second position where the sensor started to identify the crop;
identify a spatial offset between the first position and the second position; and
correct the yield map based on the spatial offset.

19. The harvesting machine of claim 11, wherein the computer device is configured to:
obtain the position data from a Global Navigation Satellite (GNS) system; and
store the position data together with the throughput value in memory.

20. The harvesting machine of claim 11, wherein:
the time delay is a first delay; and
the computer device is further configured to:
identify, based on the position data, a third time at which the harvesting machine crossed the crop edge to exit the second part of the field;
identify, based on a throughput value generated from the sensors, a fourth time when the sensors stopped identifying the crop;
identify, a time delay between the third time and the fourth time; and
correct the yield map based on the second time delay.
